(19) United States
(12) Patent Application Publication
(10) Pub. No.: US 2026/0360609 A1
(43) Pub. Date: Nov. 12, 2026

(54) ELECTRONIC COMPONENT

(71) Applicant: TDK CORPORATION, Tokyo (JP)

(72) Inventors: Yuki HASHIMOTO, Tokyo (JP); Toshiyuki ABE, Tokyo (JP); Naoaki FUJII, Tokyo (JP); Takeshi YOKOYAMA, Tokyo (JP); Takeshi OKUMURA, Tokyo (JP); Tomonaga NISHIKAWA, Tokyo (JP)

(21) Appl. No.: 19/484,047

(22) PCT Filed: May 10, 2024
(86) PCT No.: PCT/JP2024/017396

§ 371 Date: Nov. 13, 2025

(30) Foreign Application Priority Data
May 25, 2023 (JP) 2023-086321

(51) Int. Cl. H01F 27/28; H01F 27/29

(52) U.S. Cl. CPC H01F 27/2804; H01F 27/292

(57) ABSTRACT

To enhance, in an electronic component having a structure in which a plurality of coils are embedded in an element body containing a magnetic material, insulation performance between the coils. An electronic component includes: an element body containing a magnetic material; coils C1 and C2 embedded in the element body through an insulating resin layer, having their axes extending in the Z-direction, and arranged in the X-direction; and bump electrodes 21, 22, 23, and 24 embedded in the element body through an insulating resin layer, the bump electrodes 21 and 22 being connected respectively to one end and the other end of the coil C1, the bump electrodes 23 and 24 being connected respectively to one end and the other end of the coil C2. The end portions of the bump electrodes 21 to 24 in the Z-direction are exposed from a mounting surface of the element body.

### TECHNICAL FIELD

The present invention relates to an electronic component and, more particularly, to an electronic component having a structure in which a plurality of coils are embedded in an element body containing a magnetic material.

### BACKGROUND ART

Patent Document 1 discloses an electronic component having a structure in which a plurality of coils are embedded in an element body containing a magnetic material. Both ends of each of the plurality of coils are connected to a columnar bump electrode embedded in the element body.

### CITATION LIST

### Patent Document

[Patent Document 1] JP 2021-068825A

### DISCLOSURE OF THE INVENTION

### Problem to be Solved by the Invention

An array electronic component in which a plurality of coils are embedded in an element body is desired to have high insulation performance between coils.

The present disclosure relates to an electronic component having a structure in which a plurality of coils are embedded in an element body containing a magnetic material and describes a technology for enhancing insulation performance between the coils.

### Means for Solving the Problem

An electronic component according to an aspect of the present disclosure includes: an element body having a mounting surface extending in a first direction and a second direction perpendicular or substantially perpendicular to the first direction and containing a magnetic material; first and second coils embedded in the element body, having their axes extending in a third direction perpendicular or substantially perpendicular to the first and second directions, and arranged in the first direction; and first to fourth bump electrodes embedded in the element body, the first bump electrode having one end connected to one end of the first coil and the other end exposed to the mounting surface, the second bump electrode having one end connected to the other end of the first coil and the other end exposed to the mounting surface, the third bump electrode having one end connected to one end of the second coil and the other end exposed to the mounting surface, and the fourth bump electrode having one end connected to the other end of the second coil and the other end exposed to the mounting surface, wherein a first insulating resin layer is provided between each of the first and second coils and the magnetic material contained in the element body, and a second insulating resin layer is provided between each of the first, second, third, and fourth bump electrodes and the magnetic material contained in the element body.

### Advantageous Effects of the Invention

According to the present disclosure, in an electronic component having a structure in which a plurality of coils are embedded in an element body containing a magnetic material, a technology for enhancing insulation performance between the coils is provided.

### BRIEF DESCRIPTION OF THE DRAWINGS

FIG. 1 is a schematic transparent perspective view for explaining the structure of an electronic component 100 according to an embodiment of the technology described herein.

FIG. 2 is an equivalent circuit diagram of the electronic component 100.

FIG. 3 is a schematic plan view illustrating the shapes of the conductor pattern formed in the conductor layer L1.

FIG. 4 is a schematic plan view illustrating the shapes of the conductor pattern formed in the conductor layer L2.

FIG. 5 is a schematic plan view illustrating the shapes of the conductor pattern formed in the conductor layer L3.

FIG. 6 is a schematic plan view illustrating the shapes of the conductor pattern formed in the conductor layer L4.

### MODE FOR CARRYING OUT THE INVENTION

Hereinafter, preferred embodiments of the present invention will be described in detail with reference to the accompanying drawings.

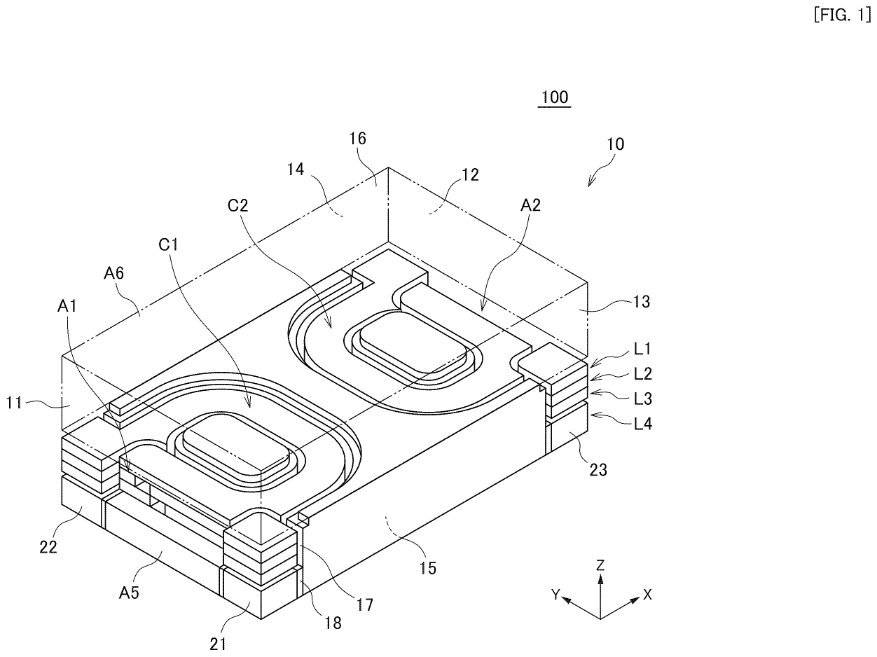

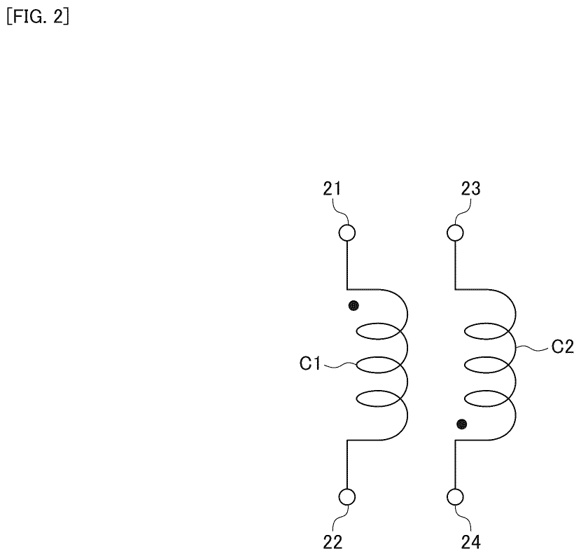

FIG. 1 is a schematic transparent perspective view for explaining the structure of an electronic component 100 according to an embodiment of the technology described herein. FIG. 2 is an equivalent circuit diagram of the electronic component 100. Hereinafter, the electronic component 100 will be referred to as “coil component 100”.

As illustrated in FIGS. 1 and 2, the coil component 100 according to the present embodiment is a four-terminal type chip component and includes an element body 10 and two coils C1 and C2 embedded in the element body 10. The element body 10 is made of a composite magnetic member containing a metal magnetic filler made of a magnetic material such as iron (Fe) or permalloy and a resin binder.

The element body 10 has side surfaces 11 and 12 which constitute the YZ surface and are positioned on mutually opposite sides, side surfaces 13 and 14 which constitute the XZ surface and are positioned on mutually opposite sides, and a mounting surface 15 and an upper surface 16 which constitute the XY surface and are positioned on mutually opposite sides. The mounting surface 15 faces a circuit board when being mounted, and four bump electrodes 21 to 24 are exposed therefrom (bump electrode 24 is not illustrated in FIG. 1). In a plan view as viewed in the Z-direction, the element body 10 is long in the X-direction and short in the Y-direction. The bump electrodes 21 and 22 are adjacent in the Y-direction, and the bump electrodes 23 and 24 are adjacent in the Y-direction. The bump electrodes 21 and 23 are adjacent in the X-direction, and the bump electrodes 22 and 24 are adjacent in the X-direction. In the specific example illustrated in FIG. 1, the bump electrode 21 may be exposed from the side surfaces 11 and 13 of the element body 10. The bump electrode 22 may be exposed from the side surfaces 11 and 14 of the element body 10. The bump electrode 23 may be exposed from the side surfaces 12 and 13 of the element body 10. The bump electrode 24 may be exposed from the side surfaces 12 and 14 of the element body 10.

The element body 10 embeds therein a plurality of conductor layers L1 to L4 stacked in the Z-direction. Conductor patterns positioned in the respective conductor layers L1 to L3 constitute coils C1 and C2, and a conductor pattern positioned in the conductor layer L4 constitutes bump electrodes 21 to 24. The coils C1 and C2 each have its axis extending in the Z-direction. The coils C1 and C2 are arranged in the X-direction which is the longer side direction. The conductor patterns positioned in the respective conductor layers L1 to L4 are each covered at its surface with an insulating resin layer so as not to directly contact the element body 10 made of a magnetic material.

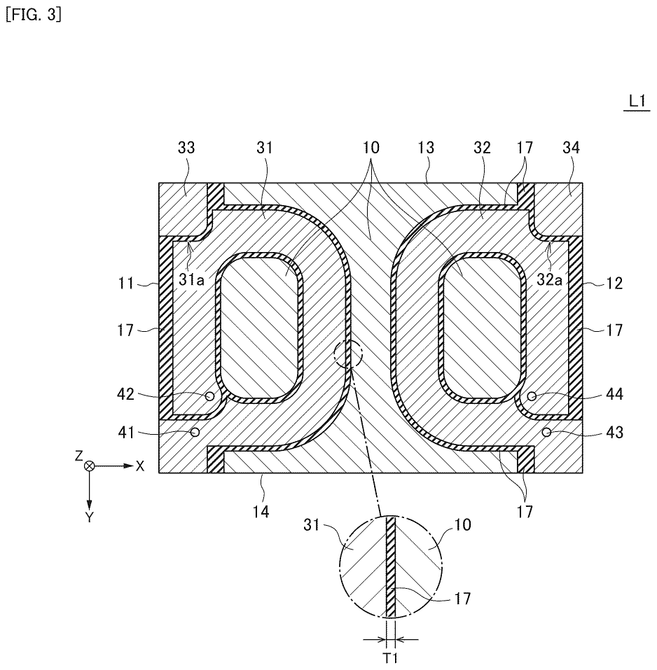

FIGS. 3 to 6 are schematic plan views illustrating the shapes of the conductor patterns formed in the respective conductor layers L1 to L4.

As illustrated in FIG. 3, the conductor pattern provided in the conductor layer L1 includes coil patterns 31 and 32 and dummy patterns 33 and 34. The coil patterns 31 and 32 are conductor patterns wound in about one turn. One ends of the coil patterns 31 and 32 are located at positions respectively overlapping the bump electrodes 22 and 24 in a plan view as viewed in the Z-direction. The dummy patterns 33 and 34 are respectively independent of the coil patterns 31 and 32 and located at positions respectively overlapping the bump electrodes 21 and 23 in a plan view as viewed in the Z-direction. One end and the other end of the coil pattern 31 are connected to the conductor layer L2 in the upper layer through respective via conductors 41 and 42. One end and the other end of the coil pattern 32 are connected to the conductor layer L2 in the upper layer through respective via conductors 43 and 44. An insulating resin layer 17 is provided between the coil patterns 31, 32 and the element body 10 and between the dummy patterns 33, 34 and the element body 10 to thereby prevent contact therebetween. The outer peripheral edges of the coil patterns 31 and 32 respectively have cutouts 31a and 32a. The dummy patterns 33 and 34 are partially respectively located within the cutouts 31a and 32a so as to respectively bite into the coil patterns 31 and 32. In other words, partially locating the dummy pattern 33 within the cutout 31a forms a pattern in which the dummy pattern 33 partially enters (protrudes) into the coil pattern 31 in a plan view as viewed in the Z-direction. Similarly, partially locating the dummy pattern 34 within the cutout 32a forms a pattern in which the dummy pattern 34 partially enters (protrudes) into the coil pattern 32 in a plan view as viewed in the Z-direction.

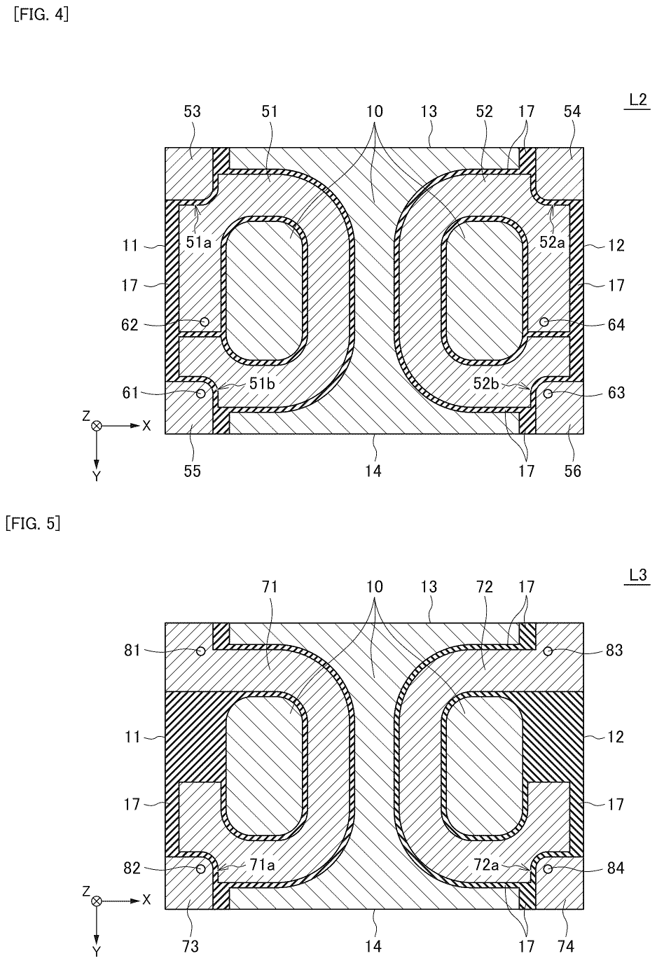

As illustrated in FIG. 4, the conductor pattern provided in the conductor layer L2 includes coil patterns 51 and 52, dummy patterns 53 and 54, and connection patterns 55 and 56. The coil patterns 51 and 52 are conductor patterns wound in about one turn. One ends of the coil patterns 51 and 52 are respectively connected to the other ends of the coil patterns 31 and 32 through the respective via conductors 42 and 44. The dummy patterns 53 and 54 are respectively independent of the coil patterns 51 and 52 and located at positions respectively overlapping the bump electrodes 21 and 23 in a plan view as viewed in the Z-direction. The connection patterns 55 and 56 are respectively independent of the coil patterns 51 and 52 and located at positions respectively overlapping the bump electrodes 22 and 24 in a plan view as viewed in the Z-direction. The connection patterns 55 and 56 are respectively connected to the one ends of the coil patterns 31 and 32 through the respective via conductors 41 and 43. The insulating resin layer 17 is provided between the coil patterns 51, 52 and the element body 10, between the dummy patterns 53, 54 and the element body 10, and between the connection patterns 55, 56 and the element body 10 to thereby prevent contact therebetween. The outer peripheral edge of the coil pattern 51 has cutouts 51a and 51b, and the outer peripheral edge of the coil pattern 52 has cutouts 52a and 52b. The dummy patterns 53 and 54 are partially respectively located within the cutouts 51a and 52a so as to respectively bite into the coil patterns 51 and 52. The connection patterns 55 and 56 are partially respectively located within the cutouts 51b and 52b so as to respectively bite into the coil patterns 51 and 52. In other words, partially locating the dummy pattern 53 within the cutout 51a forms a pattern in which the dummy pattern 53 partially enters (protrudes) into the coil pattern 51 in a plan view as viewed in the Z-direction. Similarly, partially locating the dummy pattern 54 within the cutout 52a forms a pattern in which the dummy pattern 54 partially enters (protrudes) into the coil pattern 52 in a plan view as viewed in the Z-direction. Further, partially locating the connection pattern 55 within the cutout 51b forms a pattern in which the connection pattern 55 partially enters (protrudes) into the coil pattern 51 in a plan view as viewed in the Z-direction. Similarly, partially locating the connection pattern 56 within the cutout 52b forms a pattern in which the connection pattern 56 partially enters (protrudes) into the coil pattern 52 in a plan view as viewed in the Z-direction.

As illustrated in FIG. 5, the conductor pattern provided in the conductor layer L3 includes coil patterns 71 and 72 and connection patterns 73 and 74. The coil patterns 71 and 72 are conductor patterns wound in about one turn. One ends of the coil patterns 71 and 72 are respectively connected to the other ends of the coil patterns 51 and 52 through respective via conductors 62 and 64. The other ends of the coil patterns 71 and 72 are located at positions respectively overlapping the bump electrodes 21 and 23 in a plan view as viewed in the Z-direction. The connection patterns 73 and 74 are respectively independent of the coil patterns 71 and 72 and located at positions respectively overlapping the bump electrodes 22 and 24 in a plan view as viewed in the Z-direction. The connection patterns 73 and 74 are respectively connected to the connection patterns 55 and 56 through respective via conductors 61 and 63. The insulating resin layer 17 is provided between the coil patterns 71, 72 and the element body 10 and between the connection patterns 73, 74 and the element body 10 to thereby prevent contact therebetween. The outer peripheral edges of the coil patterns 71 and 72 respectively have cutouts 71a and 72a. The connection patterns 73 and 74 are partially respectively located within the cutouts 71a and 72a so as to respectively bite into the coil patterns 71 and 72. In other words, partially locating the connection pattern 73 within the cutout 71a forms a pattern in which the connection pattern 73 partially enters (protrudes) into the coil pattern 71 in a plan view as viewed in the Z-direction. Similarly, partially locating the connection pattern 74 within the cutout 72a forms a pattern in which the connection pattern 74 partially enters (protrudes) into the coil pattern 72 in a plan view as viewed in the Z-direction.

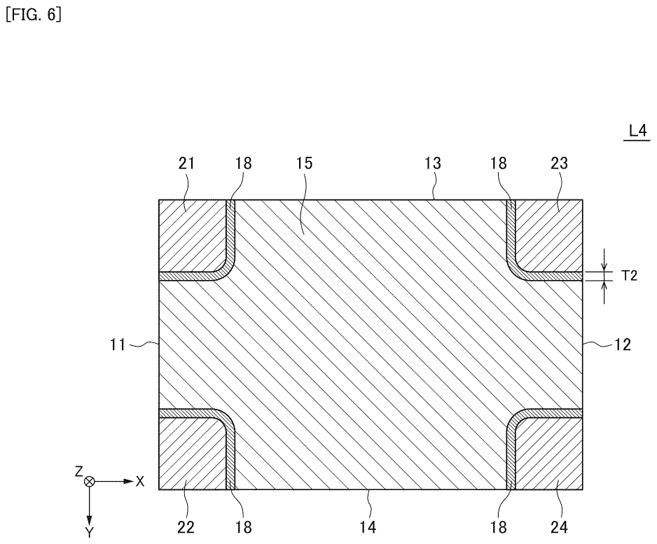

As illustrated in FIG. 6, the conductor pattern provided in the conductor layer L4 includes the bump electrodes 21 to 24. The bump electrodes 21 to 24 are respectively connected to the other end of the coil pattern 71, connection pattern 73, the other end of the coil pattern 72, and connection pattern 74 through respective via conductors 81 to 84. In a plan view as viewed in the Z-direction, the bump electrode 21 overlaps the dummy patterns 33 and 53 and has a larger area than the dummy patterns 33 and 53. In a plan view as viewed in the z-direction, the bump electrode 22 overlaps the connection patterns 55 and 73 and has a larger area than the connection patterns 55 and 73. In a plan view as viewed in the Z-direction, the bump electrode 23 overlaps the dummy patterns 34 and 54 and has a larger area than the dummy patterns 34 and 54. In a plan view as viewed in the Z-direction, the bump electrode 24 overlaps the connection patterns 56 and 74 and has a larger area than the connection patterns 56 and 74.

The surfaces of the bump electrodes 21 to 24 that are exposed from the element body 10 constitute external terminals. An insulating resin layer 18 is provided between the bump electrodes 21 to 24 and the element body 10 to thereby prevent contact therebetween. The material of the insulating resin layer 18 may be the same as or different from that of the insulating resin layer 17. The insulating resin layer 18 may contain an inorganic filler made of silica particles or the like. Adding the inorganic filler to the insulating resin layer 18 allows a reduction in the thermal expansion coefficient of the insulating resin layer 18. In this case, the thermal expansion coefficient of the insulating resin layer 18 becomes lower than that of the insulating resin layer 17. The thermal expansion coefficient of the element body 10 is lower than that of the insulating resin layer 18, and the thermal expansion coefficient of the conductor patterns is lower than that of the element body 10.

With the above-described configuration, the coil patterns 31, 51, and 71 are connected in series between the bump electrodes 21 and 22 to thereby constitute the coil C1. Similarly, the coil patterns 32, 52, and 72 are connected in series between the bump electrodes 23 and 24 to thereby constitute the coil C2. The winding direction of the coil C1 starting from the bump electrode 21 is opposite to the winding direction of the coil C2 starting from the bump electrode 23. Therefore, when, for example, the bump electrodes 21 and 23 are respectively connected to a pair of differential signal lines, and the bump electrodes 22 and 24 are connected to a power supply circuit, a differential component (signal component) flowing in the differential signal lines is not allowed to pass through the coil component 100 and thus does not flow in the power supply circuit, whereas a DC power supply component is allowed to pass through the coil component 100.

Further, the insulating resin layers 17 and 18 are interposed between the conductor patterns and the element body 10 to prevent contact therebetween, so that insulation performance between the conductor patterns and the element body 10 is ensured. A thickness T2 (see FIG. 6) in the XY plane direction of the insulating resin layer 18 positioned between each of the bump electrodes 21 to 24 and the element body 10 may be larger than a thickness Tl (see FIG. 3) in the XY plane direction of the insulating resin layer 17 positioned between each of the conductor patterns provided in the respective conductor layers L1 to L3 and the element body 10. This can enhance insulation performance between the coils C1 and C2 on the mounting surface 15 while sufficiently ensuring the pattern width of each of the conductor patterns constituting the coils Cl and C2. That is, insulation performance between the bump electrodes 21, 22 and the bump electrodes 23 and 24 to which different potentials are applied is increased. When the thicknesses T1 and T2 are not constant, they can be defined by thicknesses of thinnest portions of the insulating resin layers 17 and 18, for example.

In the present embodiment, the coils C1 and C2 are arranged in the X-direction, so that, in order to enhance insulation performance between the coils C1 and C2 on the mounting surface 15, it is sufficient to ensure the thickness of the insulating resin layer 18 in the X-direction. Thus, the thickness in the Y-direction of the insulating resin layer 18 positioned between the bump electrodes 21 to 24 and the element body 10 may be equal to or less than the thickness in the Y-direction of the insulating resin layer 17 positioned between the conductor patterns in the respective conductor layers L1 to L3 and the element body 10.

Further, in the present embodiment, the bump electrodes 21 and 22 connected to the both ends of the coil C1 are arranged in the Y-direction as the shorter side direction on the mounting surface 15. Similarly, the bump electrodes 23 and 24 connected to the both ends of the coil C2 are arranged in the Y-direction as the shorter side direction on the mounting surface 15. Further, the bump electrodes 21 and 23 are arranged in the X-direction as the longer side direction on the mounting surface 15. Similarly, the bump electrodes 22 and 24 are arranged in the X-direction as the longer side direction on the mounting surface 15. Such arrangement can make larger the distance between the bump electrodes 21 and 23 and the distance between the bump electrodes 22 and 24 than the distance between the bump electrodes 21 and 22 and the distance between the bump electrodes 23 and 24. This can further enhance insulation performance between the coils C1 and C2 on the mounting surface 15.

In addition, in the present embodiment, the bump electrodes 21 to 24 are each exposed not only from the mounting surface 15 but also from the two side surfaces of the element body, so that high mounting strength can be achieved when the coil component 100 is mounted on a circuit board. Further, the exposed areas of the bump electrodes 21 to 24 to the mounting surface 15 are larger than the areas of the dummy patterns 33, 34, 53, and 54 and connection patterns 55, 56, 73, and 74, so that high mounting strength can be achieved when the coil component 100 is mounted on a circuit board, and the diameters and conductor widths of the coil patterns 31, 32, 51, 52, 71, and 72 can be sufficiently ensured. Furthermore, in the present embodiment, the dummy patterns 33, 34, 53, and 54 and connection patterns 55, 56, 73, and 74 are laid out so as to bite into the outer peripheral edges of the coil patterns 31, 32, 51, 52, 71, and 72, so that the diameters of the coil patterns 31, 32, 51, 52, 71, and 72 can be sufficiently ensured.

While the preferred embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

An electronic component according to an aspect of the present disclosure includes: an element body having a mounting surface extending in a first direction and a second direction perpendicular or substantially perpendicular to the first direction and containing a magnetic material; first and second coils embedded in the element body, having their axes extending in a third direction perpendicular or substantially perpendicular to the first and second directions, and arranged in the first direction; and first to fourth bump electrodes embedded in the element body, the first bump electrode having one end connected to one end of the first coil and the other end exposed to the mounting surface, the second bump electrode having one end connected to the other end of the first coil and the other end exposed to the mounting surface, the third bump electrode having one end connected to one end of the second coil and the other end exposed to the mounting surface, and the fourth bump electrode having one end connected to the other end of the second coil and the other end exposed to the mounting surface, wherein a first insulating resin layer is provided between each of the first and second coils and the magnetic material contained in the element body, and a second insulating resin layer is provided between each of the first, second, third, and fourth bump electrodes and the magnetic material contained in the element body. With this configuration, even when the element body is low in insulation performance, it is possible to enhance insulation performance between the first and second coils on the mounting surface.

In the above electronic component, the thickness in the first direction of the second insulating resin layer positioned between each of the first, second, third, and fourth bump electrodes and the element body may be larger than the thickness in the first direction of the first insulating resin layer positioned between each of the first and second coils and the element body, and the thickness in the second direction of the second insulating resin layer positioned between each of the first, second, third, and fourth bump electrodes and the element body may be larger than the thickness in the second direction the first insulating resin layer positioned between each of the first and second coils and the element body. This can further enhance insulation performance between the first and second coils on the mounting surface.

In the above coil component, the first and second bump electrodes may be arranged in the second direction, the third and fourth bump electrodes may be arranged in the second direction, the first and third bump electrodes may be arranged in the first direction, the second and fourth bump electrodes may be arranged in the first direction, and the first direction may be the longer side direction of the mounting surface. This can further enhance insulation performance between the first and second coils on the mounting surface.

In the above electronic component, the element body may further have first and second side surfaces extending in the second and third directions and positioned on mutually opposite sides and third and fourth side surfaces extending in the first and third directions and positioned on mutually opposite sides, the first bump electrode may £ be exposed to the first and third side surfaces, the second bump electrode may be exposed to the first and fourth side surfaces, the third bump electrode may be exposed to the second and third side surfaces, and the fourth bump electrode may be exposed to the second and fourth side surfaces. This can enhance mounting strength when the electronic component is mounted on a circuit board.

In the above electronic component, the second insulating resin layer may contain an inorganic filler. This reduces the thermal expansion coefficient of the second insulating resin layer, making it unlikely to cause peeling between members even with an increase in the thickness of the second insulating resin layer.

In the above electronic component, the first and second coils may each be constituted by coil patterns provided in a plurality of conductor layers stacked in the third direction, a first conductor layer included in the plurality of conductor layers may have first, second, third, and fourth patterns provided independent of the coil pattern, the first pattern may have a portion overlapping the first bump electrode as viewed in the third direction, the second pattern may have a portion overlapping the second bump electrode as viewed in the third direction, the third pattern may have a portion overlapping the third bump electrode as viewed in the third direction, the fourth pattern may have a portion overlapping the fourth bump electrode as viewed in the third direction, the exposed area of the first bump electrode to the mounting surface may be larger than the area of the first pattern, the exposed area of the second bump electrode to the mounting surface may be larger than the area of the second pattern, the exposed area of the third bump electrode to the mounting surface may be larger than the area of the third pattern, and the exposed area of the fourth bump electrode to the mounting surface may be larger than the area of the fourth pattern. This can enhance mounting strength when the electronic component is mounted on a circuit board and can sufficiently ensure the diameters and conductor widths of the coil patterns.

In the above electronic component, the first conductor layer may include a first coil pattern constituting the first coil and a second coil pattern constituting the second coil, the outer peripheral edge of the first coil pattern may have first and second cutouts, the outer peripheral edge of the second coil pattern may have third and fourth cutouts, the first pattern may be partially located within the first cutout so as to bite into the first coil pattern, the second pattern may be partially located within the second cutout so as to bite into the first coil pattern, the third pattern may be partially located within the third cutout so as to bite into the second coil pattern, and the fourth pattern may be partially located within the fourth cutout so as to bite into the second coil pattern. This can sufficiently ensure the diameters of the first and second coil patterns.

This application claims the benefit of Japanese Patent Application No. 2023-086321, filed on May 25, 2023, the entire disclosure of which is incorporated by reference herein.

### REFERENCE SIGNS LIST

10 element body
11-14 side surface
15 mounting surface
16 upper surface
17, 18 insulating resin layer
21-24 bump electrode
31, 32, 51, 52, 71, 72 coil pattern
31a, 32a, 51a, 51b, 52a, 52b, 71a, 71b cutout
33, 34, 53, 54 dummy pattern
41-44, 61-64, 81-84 via conductor
55, 56, 73, 74 connection pattern
100 electronic component
C1, C2 coil
L1-L4 conductor layer
T1, T2 thickness

1. An electronic component comprising:
an element body having a mounting surface extending in a first direction and a second direction perpendicular or substantially perpendicular to the first direction and containing a magnetic material;
first and second coils embedded in the element body, axes of the first and second coils extending in a third direction perpendicular or substantially perpendicular to the first and second directions, and arranged in the first direction; and
first to fourth bump electrodes embedded in the element body, the first bump electrode having one end connected to one end of the first coil and other end exposed to the mounting surface, the second bump electrode having one end connected to other end of the first coil and other end exposed to the mounting surface, the third bump electrode having one end connected to one end of the second coil and other end exposed to the mounting surface, and the fourth bump electrode having one end connected to other end of the second coil and other end exposed to the mounting surface, and
wherein a first insulating resin layer is provided between each of the first and second coils and the magnetic material contained in the element body, and a second insulating resin layer is provided between each of the first, second, third, and fourth bump electrodes and the magnetic material contained in the element body.

2. The electronic component as claimed in claim 1,
wherein a thickness in the first direction of the second insulating resin layer positioned between each of the first, second, third, and fourth bump electrodes and the element body is larger than a thickness in the first direction of the first insulating resin layer positioned between each of the first and second coils and the element body, and
wherein a thickness in the second direction of the second insulating resin layer positioned between each of the first, second, third, and fourth bump electrodes and the element body is larger than a thickness in the second direction of the first insulating resin layer positioned between each of the first and second coils and the element body.

3. The electronic component as claimed in claim 1,
wherein the first and second bump electrodes are arranged in the second direction,
wherein the third and fourth bump electrodes are arranged in the second direction,
wherein the first and third bump electrodes are arranged in the first direction,
wherein the second and fourth bump electrodes are arranged in the first direction, and
wherein the first direction is a longer side direction of the mounting surface.

4. The electronic component as claimed in claim 2,
wherein the element body further has first and second side surfaces extending in the second and third directions and positioned on mutually opposite sides and third and fourth side surfaces extending in the first and third directions and positioned on mutually opposite sides,
wherein the first bump electrode is exposed to the first and third side surfaces,
wherein the second bump electrode is exposed to the first and fourth side surfaces,
wherein the third bump electrode is exposed to the second and third side surfaces, and
wherein the fourth bump electrode is exposed to the second and fourth side surfaces.

5. The electronic component as claimed in claim 3,
wherein the element body further has first and second side surfaces extending in the second and third directions and positioned on mutually opposite sides and third and fourth side surfaces extending in the first and third directions and positioned on mutually opposite sides,
wherein the first bump electrode is exposed to the first and third side surfaces,
wherein the second bump electrode is exposed to the first and fourth side surfaces,
wherein the third bump electrode is exposed to the second and third side surfaces, and
wherein the fourth bump electrode is exposed to the second and fourth side surfaces.

6. The electronic component as claimed in claim 1, wherein the second insulating resin layer contains an inorganic filler.

7. The electronic component as claimed in claim 1,
wherein each of the first and second coils is constituted by coil patterns provided in a plurality of conductor layers stacked in the third direction,
wherein a first conductor layer included in the plurality of conductor layers has first, second, third, and fourth patterns provided independent of the coil pattern,
wherein the first pattern has a portion overlapping the first bump electrode as viewed in the third direction, the second pattern has a portion overlapping the second bump electrode as viewed in the third direction, the third pattern has a portion overlapping the third bump electrode as viewed in the third direction, and the fourth pattern has a portion overlapping the fourth bump electrode as viewed in the third direction, and
wherein an exposed area of the first bump electrode to the mounting surface is larger than an area of the first pattern, an exposed area of the second bump electrode to the mounting surface is larger than an area of the second pattern, an exposed area of the third bump electrode to the mounting surface is larger than an area of the third pattern, and an exposed area of the fourth bump electrode to the mounting surface is larger than an area of the fourth pattern.

8. The electronic component as claimed in claim 7,
wherein the first conductor layer includes a first coil pattern constituting the first coil and a second coil pattern constituting the second coil,
wherein an outer peripheral edge of the first coil pattern has first and second cutouts,
wherein an outer peripheral edge of the second coil pattern has third and fourth cutouts,
wherein the first pattern is partially located within the first cutout so as to bite into the first coil pattern,
wherein the second pattern is partially located within the second cutout so as to bite into the first coil pattern,
wherein the third pattern is partially located within the third cutout so as to bite into the second coil pattern, and
wherein the fourth pattern is partially located within the fourth cutout so as to bite into the second coil pattern.
